(19) United States
(12) Patent Application Publication
(10) Pub. No.: US 2008/0206482 A1
(43) Pub. Date: Aug. 28, 2008

(54) DROPLET JETTING APPLICATOR AND METHOD OF MANUFACTURING COATED BODY

(75) Inventor: Hiroyasu KONDO, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/037,437

(22) Filed: Feb. 26, 2008

(30) Foreign Application Priority Data
Feb. 27, 2007 (JP) 2007-047207
Feb. 19, 2008 (JP) 2008-037443

(51) Int. Cl. B05D 3/06; B05C 9/08

(52) U.S. Cl. 427/554; 118/620

(57) ABSTRACT

The droplet jetting applicator includes an irradiator and a droplet jetting head. The irradiator is configured to irradiate, to a water-repellent film formed on a surface of an application target, a light beam for removing the water-repellent film. The droplet jetting head is configured to jet a droplet to each of multiple hydrophilic regions of the surface of the application target, each of the hydrophilic regions being exposed to the outside in a dot shape by removing the water-repellent film.

### CROSS REFERENCE OF THE RELATED APPLICATION

This application is based on and claims the benefit of priority from Japanese Patent Applications No. 2007-047207, filed on Feb. 27, 2007 and No. 2008-037443, filed on Feb. 19, 2008; the entire contents of which are incorporated herein by reference.

### BACKGROUND OF THE INVENTION

1. Field of the Invention

The present invention relates to a droplet jetting applicator that jets and thus applies multiple droplets to an object to be coated, and also relates to a method of manufacturing a coated body.

2. Description of the Related Art

Droplet jetting applicators have been used not only for printing of image information, but also for a process of manufacturing various kinds of flat display devices, such as liquid crystal display devices, organic electro luminescence (EL) display devices, electron emission display devices, plasma display devices, and electrophoretic display devices (see, for example, Shimoda Tatsuya, “MAIKUROEKITAI KARA CHOKUSETSU-NI HAKUMAKU-DEBAISU WO KEISEI-SURU GIJUTSU-MAIKUROEKITAI-PUROSESU-2. MUKI-HAKUMAKU HENO TEKIYOU TO KYOUMI-ARU OUYOU,” MATERIA (Materia Japan), The Japan Institute of Metals, 2005, volume 44, No. 5, chapter 2.3.1, pp. 414 to 415).

Such a droplet jetting applicator includes a droplet jetting head (for example, an inkjet head) that jets droplets from multiple nozzles thereof to an object, such as a substrate, to which a liquid is to be applied (hereinafter, such object will be referred to as an application target). Multiple droplets are jetted to land on the application target by the droplet jetting head, so that a predetermined application pattern is formed. In this manner, various kinds of coated bodies are manufactured. It should be noted that a water-repellent film (liquid-repellent film) for controlling the landing area (contact angle) of a landing droplet is formed on a surface, to which the liquid is to be applied, of the application target (hereinafter, such surface will be referred to as an application surface).

However, in the case of the above-described droplet jetting applicator, a droplet having landed on the water-repellent surface sometimes moves in a sliding manner to be displaced from its predetermined landing position (application position). As a result, the landing positions of droplets are misaligned. In addition, the condition of the water-repellent surface generally changes with time until the application operation is performed thereon. Such change with time may cause a variation in landing areas (landing diameters or application areas) of droplets.

### SUMMARY OF THE INVENTION

An object of the present invention is to provide a droplet jetting applicator capable of preventing displacement of a landing position of a droplet and variations in landing area, and to provide also a method of manufacturing a coated body.

A first aspect of an embodiment of the present invention provides a droplet jetting applicator. The droplet jetting applicator of the first aspect is characterized by including: an irradiator configured to irradiate, to a water-repellent film formed on a surface of an application target, a light beam for removing the water-repellent film; and a droplet jetting head configured to jet a droplet to each of multiple hydrophilic regions of the surface of the application target, each of the hydrophilic regions being exposed to the outside in a dot shape by removing the water-repellent film.

A second aspect of the embodiment of the present invention provides a method of manufacturing a coated body. The method of the second aspect is characterized by including: irradiating, to a water-repellent film formed on a surface of an application target, a light beam for removing the water-repellent film; and jetting a droplet to each of multiple hydrophilic regions of the surface of the application target, each of the hydrophilic regions being exposed to the outside in a dot shape by removing the water-repellent film.

### BRIEF DESCRIPTION OF THE DRAWINGS

FIG. 1 is a perspective view showing a schematic configuration of a droplet jetting applicator according to a first embodiment of the present invention.

FIG. 2 is a schematic view showing a schematic configuration of an irradiation-head unit included in the droplet jetting applicator shown in FIG. 1.

FIG. 3 is a side view for explaining an application operation performed by the droplet jetting applicator shown in FIG. 1.

FIG. 4 is a plan view for explaining the application operation performed by the droplet jetting applicator shown in FIG. 1.

FIG. 5 is a schematic view showing a schematic configuration of a modification of an optical system in an irradiation-head unit included in a droplet jetting applicator according to a second embodiment of the present invention.

FIG. 6 is a perspective view showing a schematic configuration of a droplet jetting applicator according to a third embodiment of the present invention.

FIG. 7 is a schematic view showing a schematic configuration of an irradiation-head unit included in the droplet jetting applicator shown in FIG. 6.

FIG. 8 is a flowchart showing the flow of an application operation performed by the droplet jetting applicator shown in FIG. 6.

FIG. 9 is a plan view showing a substrate used in the application operation performed by the droplet jetting applicator shown in FIG. 6.

FIG. 10 is a schematic view for explaining an alignment in the flow of the application operation shown in FIG. 8.

FIG. 11 is another schematic view for explaining the alignment in the flow of the application operation shown in FIG. 8.

FIG. 12 is a schematic view for explaining correction performed in accordance with expansion or shrinkage of a substrate.

### DETAILED DESCRIPTION OF THE PREFERRED EMBODIMENTS

### First Embodiment

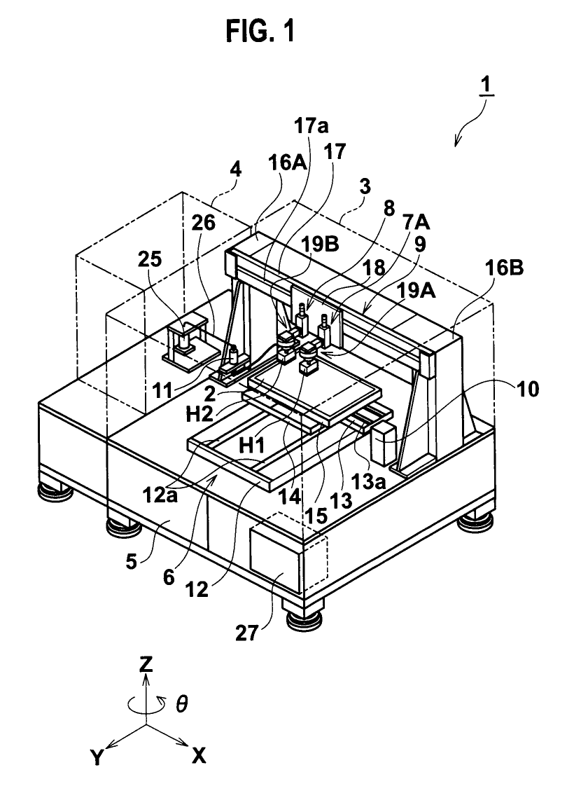

A first embodiment of the present invention will be described with reference to FIGS. 1 to 4.

As shown in FIG. 1, a droplet jetting applicator 1 according to the first embodiment of the present invention includes an ink application box 3 and an ink supply box 4. The ink application box 3 applies, as droplets E, a liquid ink to a substrate 2 that is an application target. The ink supply box 4 supplies the ink to the ink application box 3. The ink application box 3 and the ink supply box 4 are fixed, adjacent to each other, to the upper surface of a base 5.

Inside the ink application box 3, provided are a substrate moving mechanism 6, an irradiation-head unit 7A, a droplet-jetting-head unit 8, a unit moving mechanism 9, a head maintenance unit 10, and an ink buffer tank 11. The substrate moving mechanism 6 holds the substrate 2, and moves the substrate 2 in the X direction and the Y direction. The irradiation-head unit 7A includes an irradiation head H1 that irradiates light beams on the substrate 2. The droplet-jetting-head unit 8 includes a droplet jetting head H2 that jets droplets E to the substrate 2. The unit moving mechanism 9 moves the irradiation-head unit 7A and the droplet-jetting-head unit 8 integrally in the X direction. The head maintenance unit 10 cleans up the droplet jetting head H2. The ink is stored in the ink buffer tank 11.

The substrate moving mechanism 6 includes a Y-direction guide plate 12, a Y-direction moving table 13, an X-direction moving table 14, and a substrate holding table 15. The Y-direction guide plate 12, the Y-direction moving table 13, the X-direction moving table 14, and the substrate holding table 15 are all formed in a plate shape, and are stacked on the upper surface of the base 5. The substrate moving mechanism 6 functions as a moving mechanism configured to cause the substrate 2 and each of the irradiation head H1 and the droplet jetting head H2 to move relative to each other so that the substrate 2 can pass through an irradiation position on which the irradiation head H1 irradiates a light beam, and also an application position to which the droplet jetting head H2 jets a droplet.

The Y-direction guide plate 12 is fixed to the upper surface of the base 5. Multiple guide grooves 12a are provided, along the Y-direction, in the upper surface of the Y-direction guide plate 12. These guide grooves 12a guide the Y-direction moving table 13 in the Y-direction.

The Y-direction moving table 13 has, on the lower surface thereof, multiple protrusions (not illustrated) each engaging with a corresponding one of the guide grooves 12a. The Y-direction moving table 13 is provided on the upper surface of the Y-direction guide plate 12 so as to be movable in the Y-direction. Moreover, multiple guide grooves 13a are provided, along the X-direction, in the upper surface of the Y-direction moving table 13. The Y-direction moving table 13 is moved in the Y direction, along the guide grooves 12a, by a feed mechanism (not illustrated) using a feed screw and a drive motor.

The X-direction moving table 14 has, on the lower surface thereof, multiple protrusions (not illustrated) each engaging with a corresponding one of the guide grooves 13a. The X-direction moving table 14 is provided on the upper surface of the Y-direction moving table 13 so as to be movable in the X-direction. The X-direction moving table 14 is moved in the X direction, along the guide grooves 13a, by a feed mechanism (not illustrated) using a feed screw and a drive motor.

The substrate holding table 15 is fixed to the upper surface of the X-direction moving table 14. The substrate holding table 15 includes a suction mechanism (not illustrated) for sucking the substrate 2. The substrate holding table 15 fixes and thus holds the substrate 2 on the upper surface of the table 15 by using the suction mechanism. As the suction mechanism, for example, an air suction mechanism is used.

The unit moving mechanism 9 includes a pair of support columns 16A and 16B, an X-direction guide plate 17, and a base plate 18. The pair of support columns 16A and 16B stand on the upper surface of the base 5. The X-direction guide plate 17 is joined to the upper end portions of these support columns 16A and 16B, and extends in the X direction. The base plate 18 is provided on the X-direction guide plate 17 so as to be movable in the X direction, and supports the irradiation-head unit 7A and the droplet-jetting-head unit 8.

The pair of support columns 16A and 16B are provided to sandwich the Y-direction guide plate 12 in between in the X direction. In addition, a guide groove 17a is provided along the X direction in the front surface of the X-direction guide plate 17. The guide groove 17a guides the base plate 18 in the X direction.

The base plate 18 has, on the back surface thereof, a protrusion (not illustrated) engaging with the guide groove 17a, and is provided on the X-direction guide plate 17 to be movable in the X direction. The base plate 18 is moved in the X direction, along the guide groove 17a, by a feed mechanism (not illustrated) using a feed screw and a drive motor. The irradiation-head unit 7A and the droplet-jetting-head unit 8 are attached to the front surface of the base plate 18.

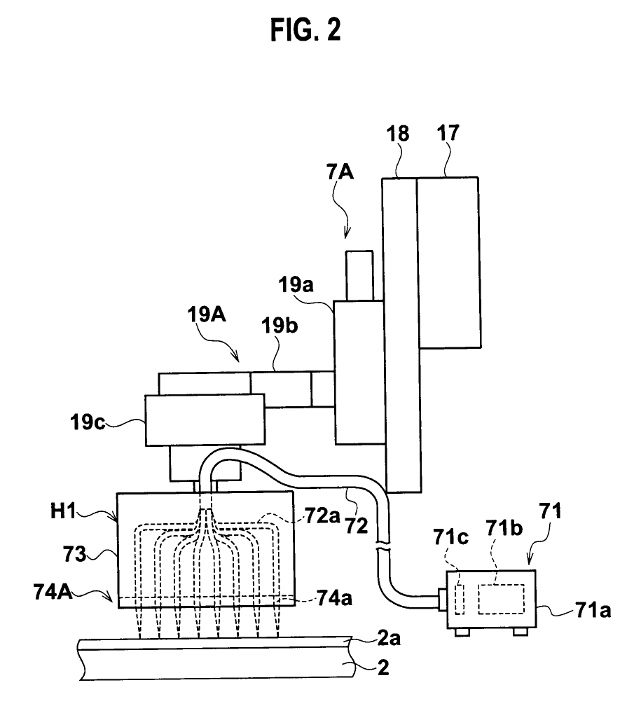

As shown in FIG. 2, the irradiation-head unit 7A includes the irradiation head H1 and a first supporting mechanism 19A. The irradiation head H1 irradiates light beams to the surface of the substrate 2, and the first supporting mechanism 19A movably supports the irradiation head H1.

Here, the surface of the substrate 2 is rendered water-repellent, that is, a water-repellent film 2a for controlling the landing area (contact angle) of a landing droplet E is formed on the surface of the substrate 2. The water-repellent film 2a is formed of a material (for example, a silane coupling agent) that is evaporated by heat of a light beam irradiated by the irradiation head H1.

The irradiation head H1 is connected, with a fiber cable 72, to a light source unit 71 that emits light. The irradiation head H1 includes a head body 73, multiple fibers 72a, and an optical system 74A. The head body 73 is a case for the irradiation head H1. The multiple fibers 72a extend through the inside of the fiber cable 72, and are aligned with one another inside the head body 73. The optical system 74A focuses a light beam guided by each fiber 72a, in a dot shape, onto the surface of the water-repellent film 2a on the substrate 2. Note that, the irradiation head H1 functions as an irradiator.

The light source unit 71 is provided inside the base 5, and includes a body 71a, a light source 71b, and a shutter 71c. The body 71a is a case for the light source unit 71. The light source 71b is provided inside the body 71a, and generates light beams (for example, ultraviolet rays). The shutter 71c blocks the light beams from the light source 71b. The shutter 71c is located on a light path through which the light beams from the light source 71b travels to enter the fiber cable 72. The shutter 71c is provided to be movable between a standby position where the shutter 71c blocks the light beams, and an irradiating position where the shutter 71c allows, without blocking, the light beams to travel. Note that, as the light source 71b, for example, an UV (ultraviolet) light source, such as a xenon lamp and an excimer lamp, is used. A light beam emitted from such light source unit 71 is guided by the fiber cable 72 to be supplied to the irradiation head H1.

The optical system 74A includes, for example, multiple microlenses 74a each focusing a light beam in a circular shape onto the surface of the water-repellent film 2a on the substrate 2. These microlenses 74a are arranged in-line in a manner that the pitch (the interval) of the respective focal points of light coincides with the one of corresponding nozzles (to be described later) of the droplet jetting head H2. With these microlenses 74a, light beams are irradiated each in the circular dot shape on the surface of the water-repellent film 2a on the substrate 2. Note that, the diameter of each microlens 74a is set in accordance with a desired landing area (landing diameter).

The first supporting mechanism 19A is fixed to the base plate 18. The first supporting mechanism 19A includes a Z-direction moving mechanism 19a, a Y-direction moving mechanism 19b, and a θ-direction rotating mechanism 19c. The Z-direction moving mechanism 19a moves the irradiation head H1 in a direction perpendicular to the application surface of the substrate 2 on the substrate holding table 15, that is, in the Z direction. The Y-direction moving mechanism 19b moves the irradiation head H1 in the Y direction, and the θ-direction rotating mechanism 19c rotates the irradiation head H1 in the θ direction. The first supporting mechanism 19A thus allows the irradiation head H1 to move in the Z direction and in the Y direction, and also to rotate in the θ direction.

Refer back to FIG. 1. The droplet-jetting-head unit 8 includes the droplet jetting head H2 and a second supporting mechanism 19B. The droplet jetting head H2 jets multiple droplets E to the surface of the substrate 2. The second supporting mechanism 19B is provided on the base plate 18, and movably supports the droplet jetting head H2.

The droplet jetting head H2 includes a nozzle plate, multiple piezoelectric elements, and the like (all of which are not illustrated). The nozzle plate has the aforementioned multiple nozzles (through-holes) for jetting droplets E therethrough, while the piezoelectric elements are provided to correspond to the respective nozzles. These nozzles are provided in-line at a predetermined pitch in the nozzle plate. The number of these nozzles is, for example, on the order of 64, 128, or 256. The diameter of each nozzle is, for example, on the order of 50 μm to 100 μm. The pitch of these nozzles is, for example, on the order of 0.5 mm. The droplet jetting head H2 jets droplets (ink droplets) E through the respective nozzles to the substrate 2 in response to application of driving voltages to the respective piezoelectric elements. The droplet jetting head H2 thereby applies droplets E to the surface of the substrate 2, thus forming a predetermined application pattern on the surface.

The second supporting mechanism 19B is fixed to the base plate 18. As in the case of the first supporting mechanism 19A (see FIG. 2), the second supporting mechanism 19B includes a Z-direction moving mechanism 19a, a Y-direction moving mechanism 19b, and a θ-direction rotating mechanism 19c. The Z-direction moving mechanism 19a moves the droplet jetting head H2 in a direction perpendicular to the application surface of the substrate 2 on the substrate holding table 15, that is, in the Z direction. The Y-direction moving mechanism 19b moves the droplet jetting head H2 in the Y direction, and the θ-direction rotating mechanism 19c rotates the droplet jetting head H2 in the θ direction. The first supporting mechanism 19B thus allows the droplet jetting head H2 to move in the Z direction and in the Y direction, and also to rotate in the θ direction.

The head maintenance unit 10 is provided on the upper surface of the base 5, on the extended line of the moving direction of the droplet-jetting-head unit 8, and also to be separated from the Y-direction guide plate 12. The head maintenance unit 10 cleans the droplet jetting head H2 of the droplet-jetting-head unit 8. Note that, the head maintenance unit 10 cleans automatically the droplet jetting head H2 in a state where the droplet jetting head H2 stays at a maintenance position, facing the head maintenance unit 10.

The ink buffer tank 11 adjusts the liquid level (meniscus) of ink on the tip of each nozzle by utilizing the head difference (difference in head pressure) between the liquid level of the ink stored in the ink buffer tank 11 and the level of the nozzle surface of the droplet jetting head H2. This ink buffer tank 11 thereby prevents leakage and jetting failure of the ink.

Multiple ink tanks 25 for storing ink are detachably provided inside the ink supply box 4. Each of the ink tanks 25 is connected by a supply pipe 26 to the droplet jetting head H2 via the ink buffer tank 11. The droplet jetting head H2 is thus supplied with ink from the ink tanks 25 via the ink buffer tank 11.

Here, various kinds of ink may be used as the ink. The ink is a solution consisting of, for example, a solute which remains as a residue on the substrate 2, and a solvent in which the solute is dissolved (dispersed). As such solution, used is, for example, ink that contains water, a water-absorbing solvent with a low vapor pressure (for example, ethylene glycol, abbreviated as “EG”), a water-soluble high polymer material (for example, polyvinylpyrrolidone, abbreviated as “PVP,” or polyvinyl alcohol, abbreviated as “PVA”), a water-soluble film material, and the like.

A controller 27 for controlling each section of the droplet jetting applicator 1 is provided inside the base 5. The controller 27 includes: a control unit, such as a CPU, that integrally controls those sections; and a storage unit that stores, for example, various programs, and application information about the application of droplets to the substrate (all of which are not illustrated). In addition, an input unit (not illustrated) that is manipulated by the operator is connected to the controller 27. Note that, the application information mentioned here is information about the application operation performed on the substrate 2, and includes the application pattern (for example, a dot pattern), the transporting speed of the substrate 2, the irradiating time, the irradiating timing, the jetting timing, and the like.

The controller 27 performs various control operations on the basis of the application information and by using the various programs. Specifically, the controller 27 controls the movement of the Y-direction moving table 13, the movement of the X-direction moving table 14, the movement of the base plate 18, the first supporting mechanism 19A, the second supporting mechanism 19B, the light source unit 71, and the like. With the operation of the controller 27, the relative position of the substrate 2 to the irradiation head H1 on the substrate holding table 15 can be variously changed, and concurrently, the relative position of the substrate 2 to the droplet jetting head H2 on the substrate holding table 15 can also be variously changed.

Next, the application operation (application process) performed by the droplet jetting applicator 1 will be described. Note that, the controller 27 of the droplet jetting applicator 1 processes the application operation so as to control the drive of each section.

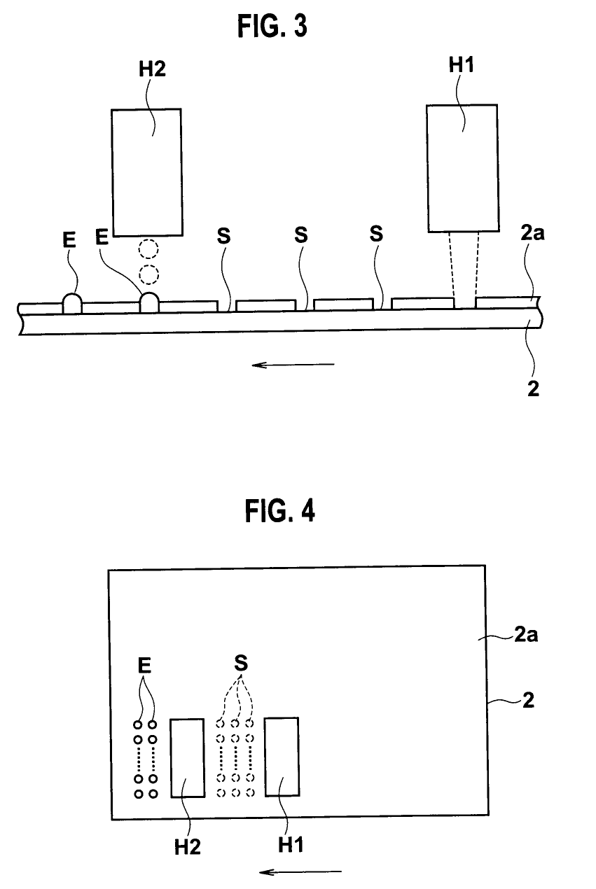

In the application operation, as shown in FIGS. 3 and 4, light beams for removing the water-repellent film 2a are firstly irradiated, each in the dot shape, onto the water-repellent film 2a formed on the surface of the substrate 2. In this way, multiple hydrophilic regions S are formed by removing the water-repellent film 2a from the surface of the substrate 2. Thereafter, droplets E are jetted respectively to the multiple hydrophilic regions S of the surface of the substrate 2. Note that, the arrows in FIGS. 3 and 4 indicate the moving direction of the substrate 2.

In other words, the controller 27 controls each section of the ink application box 3 on the basis of the application information, thus performing the application operation by which droplets E are applied to the substrate 2 on the substrate holding table 15. Specifically, the controller 27 performs an irradiation operation by which light beams are irradiated onto the moving substrate 2, and a jetting operation by which droplets E are jetted to the substrate 2. It should be noted that, the water-repellent film 2a is formed in advance on the surface of the substrate 2 on the substrate holding table 15.

Firstly, the controller 27 controls the Y-direction moving table 13 and the base plate 18, so that the droplet-jetting-head unit 8 is moved from a standby position to an application starting position facing the substrate 2. The controller 27 also controls the first supporting mechanism 19A and the second supporting mechanism 19B, so that the irradiation head H1 and the droplet jetting head H2 are rotated in the θ direction, and stopped with the same predetermined angle. This angle makes the pitch of the focal points and the landing pitch of the droplets E coincide with each other.

Subsequently, the controller 27 controls the Y-direction moving table 13, and controls also the shutter 71c of the light source unit 71 as well as the droplet jetting head H2. With this control, light beams are irradiated, each in the dot shape, onto the substrate 2 by the irradiation head H1, and then multiple droplets E are jetted to the substrate 2 by the droplet jetting head H2. Accordingly, the droplets E are applied in a dot-line pattern sequentially on the surface of the substrate 2 to form the application pattern thereon. Note that, the irradiating time is set so that the water-repellent film 2a on the substrate 2 can be evaporated by the thermal energy of the light beam in the irradiating time. Meanwhile, the shutter 71c of the light source unit 71 intermittently moves between its standby position and its irradiating position on the basis of the irradiating time and the irradiating timing.

At this time, in accordance with the intermittent movement of the shutter 71c based on the irradiating time and the irradiating timing, the irradiation head H1 sequentially irradiates light beams, in a dot line aligned with the X-direction, onto the water-repellent film 2a on the substrate 2 moving in the Y-direction (see FIGS. 3 and 4). Accordingly, irradiated portions of the water-repellent film 2a on the substrate 2 are evaporated by the heat, so that corresponding portions of the surface of the substrate 2 are exposed to the outside each in a dot shape. In this manner, the multiple hydrophilic regions (hydrophilic portions) S of the surface of the substrate 2 are sequentially formed in a dot-line pattern aligned with the X direction. Each of these hydrophilic regions S is formed in a circular shape. After that, in accordance with the jetting timing, the droplet jetting head H2 causes droplets E to land on, and thus applies the droplets E to, the corresponding hydrophilic regions S on the substrate 2 moving in the Y direction. As a result, the dot-line patterns each aligned with the X direction are formed sequentially in the Y direction, so that the application pattern is completed (see FIGS. 3 and 4). Note that, the jetting timing is set in accordance with the transporting speed of the substrate 2 so that each of the droplets E can land on a corresponding one of the hydrophilic regions S on the substrate 2.

With the above-described application operation, the droplets E having landed on the hydrophilic regions S are prevented from moving in a sliding manner due to the water-repellent film 2a surrounding the hydrophilic regions S. Accordingly, each of the landing droplets E is prevented from being displaced from its predetermined landing position. In addition, for example, even when one of the droplets E lands on the boundary between its corresponding hydrophilic region S and the water-repellent film 2a, that droplet E is drawn by the hydrophilic region S to be positioned on the hydrophilic region S. Moreover, the areas of the hydrophilic regions S are uniformly formed, and the droplets E are applied thereto. Accordingly, since the landing area of each droplet E coincides with the area of each hydrophilic region S, the droplets E are allowed to have a uniform landing diameter.

As described above, according to the first embodiment of the present invention, the water-repellent film 2a is firstly formed on the surface of the substrate 2, and then, the light beam for removing the water-repellent film 2a is irradiated in the dot shape onto the water-repellent film 2a. With the irradiation, the water-repellent film 2a is removed in the dot shape, so that the multiple hydrophilic regions S, which are parts of the substrate 2, are exposed to the outside in the dot pattern. Then, the droplets E are jetted to the hydrophilic regions S thus exposed. Accordingly, the droplets E having landed on the hydrophilic regions S are prevented from moving in a sliding manner, due to the water-repellent film 2a surrounding the hydrophilic regions S. The droplets E are thereby prevented from being displaced from the respective landing positions. As a result, displacement of the landing positions of the droplets E can be prevented. Furthermore, the areas of the hydrophilic regions S are uniformly formed, and then the droplets E are applied to the hydrophilic regions S. For this reason, the landing areas of the droplets E can be made uniform without being affected by change of the water-repellent surface with time. As a result, variation in landing areas (landing diameters) can be prevented.

In addition, the optical system 74A, which focuses light beams in the circular dot shape onto the surface of the water-repellent film 2a, is provided. The provision of the optical system 74A makes it easy to form each hydrophilic region S in the circular dot shape. Accordingly, the application pattern formed of the collection of dots can be formed with a simple configuration.

Moreover, by applying droplets E to the substrate 2, which is the target of application, by using the above-described droplet jetting applicator 1, various kinds of coated bodies are manufactured. Accordingly, manufacturing failure of coated bodies can be prevented from occurring. Moreover, coated bodies with high reliability can be obtained.

### Second Embodiment

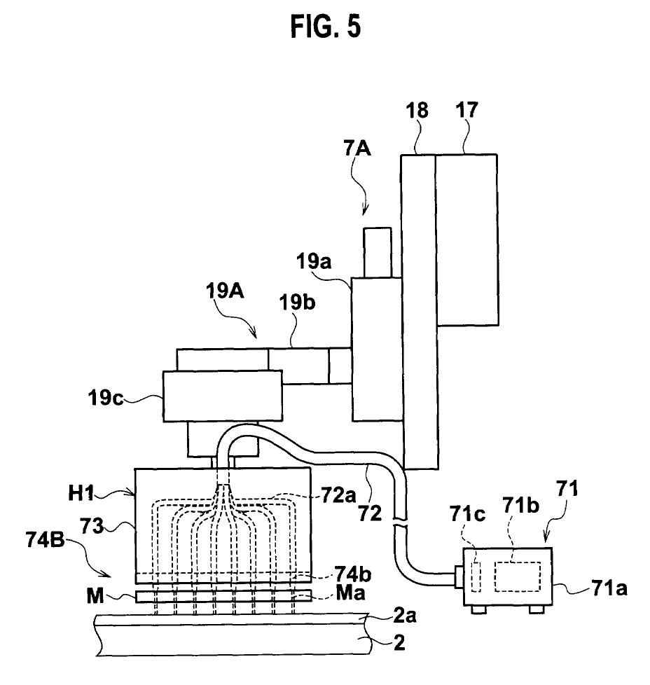

A second embodiment of the present invention will be described with reference to FIG. 5.

The second embodiment of the present invention is a modification of the first embodiment. Accordingly, description will be given particularly of part different from the first embodiment, that is, of an optical system 74B. Note that, in the second embodiment, the same part as that has been described in the first embodiment will not be described.

In the first embodiment, the optical system 74A is configured of the multiple microlenses 74a. However, the present invention is not limited to this, and the optical system 74B may be configured, as shown in FIG. 5, of multiple lenses 74b and a pattern mask M, instead of the multiple microlenses 74a. Each of the lenses 74b is provided in place of the corresponding microlens 74a. In addition, multiple through-holes Ma are formed in-line in the pattern mask M. Each of the through-holes Ma is formed in a circular shape, and has a diameter that is determined in accordance with a desired landing area (landing diameter). The pattern mask M is placed, at a position coming into the vicinity of the water-repellent film 2a on the substrate 2, and also so that the through-holes Ma face the lenses 74b, respectively. In addition, the pattern mask M is provided to be fixed to the irradiation head H1. Note that, the pattern mask M moves along with the irradiation head H1. According to the second embodiment of the present invention, the same effects as those of the first embodiment can be obtained. Moreover, the areas and shapes of the hydrophilic regions S can be easily changed with a type of the pattern mask M.

### Third Embodiment

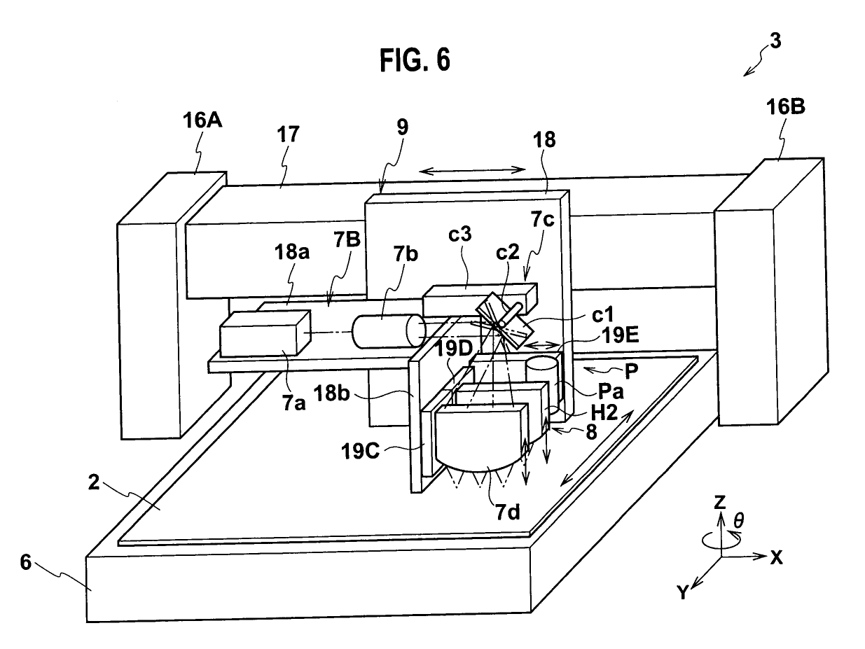

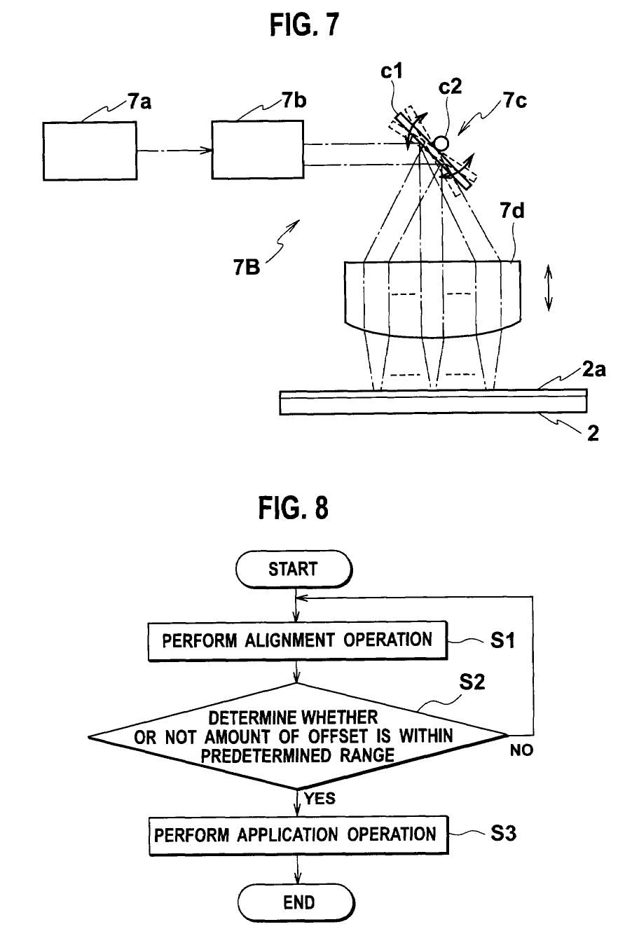

A third embodiment of the present invention will be described with reference to FIGS. 6 to 12.

The third embodiment of the present invention is a modification of the first embodiment. Accordingly, description will be given particularly of part different from the first embodiment, that is, of an irradiation-head unit 7B and an imaging unit P. Note that, in the third embodiment, the same part as that has been described in the first embodiment will not be described.

As shown in FIG. 6, the irradiation-head unit 7B includes a laser light source 7a, a beam enlarger 7b, a deflection scanner 7c, and a condenser lens 7d. The laser light source 7a intermittently emits laser beams as light beams for removing the water-repellent film 2a on the substrate 2. The beam enlarger 7b expands the emitted laser beams. The deflection scanner 7c deflects each of the expanded laser beams for scanning in synchronization with the intermittent operation of the laser light source 7a. The condenser lens 7d focuses each of the scanned laser beams onto the water-repellent film 2a on the substrate 2 on the substrate moving mechanism 6. In this embodiment the irradiation-head unit 7B functions as an irradiation unit.

The laser light source 7a is provided on a first supporting plate 18a fixed to the base plate 18. The laser light source 7a is controlled by the controller 27. The laser light source 7a intermittently emits the laser beam in accordance with a pulse signal (corresponding to the emission pulse of laser beams) transmitted thereto as a control signal from the controller 27. Note that, the first supporting plate 18a is fixed to the base plate 18 substantially in parallel with the mounting surface of the substrate holding table 15 (see FIG. 1) of the substrate moving mechanism 6.

The beam enlarger 7b is provided on the first supporting plate 18a to be positioned in the light path of the laser beam. The beam enlarger 7b expands the laser beam emitted from the laser light source 7a so as to convert the laser beam into a parallel beam. As the beam enlarger 7b, for example, a beam expander is employed.

The deflection scanner 7c includes a deflector c1 that deflects a laser beam, a rotation shaft c2 fixed to the deflector c1, and a drive source c3 that rotates the rotation shaft c2. The deflection scanner 7c causes the drive source c3 to rotate the deflector c1 in synchronization with the pulse signal transmitted as the control signal to the laser light source 7a, so as to sequentially change the inclination angle of the deflector c1. In this manner, the deflection scanner 7c scans a laser beam while changing the deflection direction of the laser beam.

The deflector c1 is provided in the light path of the laser beam. The deflector c1 deflects, to the condenser lens 7d, the laser beam expanded by the beam enlarger 7b. As the deflector c1, for example, a galvano mirror, a polygon mirror (rotating polygon mirror), or the like, is used. The rotation shaft c2 is fixed to a position that allows the deflector c1 to deflect the laser beam. The drive source c3 is provided on the first supporting plate 18a. The drive source c3 is controlled by the controller 27. Specifically, the drive source c3 is controlled so that the rotation of the deflector c1 can synchronize with the pulse signal (corresponding to the emission pulse of the laser beam). With this control, the deflection scanner 7c scans the laser beam in synchronization with the intermittent operation (intermittent interval) of the laser light source 7a.

The condenser lens 7d is provided on a second supporting plate 18b with a third supporting mechanism 19C in between. The second supporting plate 18b is fixed to the base plate 18 to be substantially perpendicular to the first supporting plate 18a. The condenser lens 7d is an f-θ lens which is a lens uniformly correcting the scanning speed of a laser beam. The condenser lens 7d is formed to have a width larger than an application width, in which two or more adjacent droplets E are arranged, of the droplet jetting head H2. This structure makes it possible to form the hydrophilic regions S aligned in a row within the width corresponding to the application width, in one time of scanning of the laser beam. Note that, the third supporting mechanism 19C is a Z-direction moving mechanism supporting the condenser lens 7d, and moving the supported condenser lens 7d in the Z direction.

The droplet jetting head H2 is provided on the second supporting plate 18b with a fourth supporting mechanism 19D in between. The fourth supporting mechanism 19D is a Z-direction and θ-direction rotating mechanism supporting the droplet jetting head H2, moving the supported droplet jetting head H2 in the Z direction, and also rotating the supported droplet jetting head H2 in the θ direction.

The imaging unit P includes an imaging part Pa and a fifth supporting mechanism 19E. The imaging part Pa performs an imaging operation on the substrate 2 on the substrate moving mechanism 6. The fifth supporting mechanism 19E supports the imaging part Pa, and moves the supported imaging part Pa in the X direction. The imaging part Pa is provided to the second supporting plate 18b with the fifth supporting mechanism 19E. The imaging part Pa has an auto focus function by which the imaging part Pa can automatically focus. As the imaging part Pa, for example a CCD (Charge Coupled Device) camera is used.

Next, the application operation (application process), including an alignment process, which is performed by the above-described droplet jetting applicator 1 will be described. Note that, in the third embodiment of the present invention, the alignment process is performed prior to the application operation according to the first embodiment. In the alignment process, the irradiation position of each laser beam is aligned with the landing position of a corresponding droplet E.

In the alignment process, the droplet jetting head H2 is allowed to move only in the θ direction (the angle of the droplet jetting head H2 in the θ direction is allowed to be changed), the imaging part Pa is allowed to move only in the X direction, and the condenser lens 7d is fixed. Here, the irradiation size of a laser beam is set (at, for example, a diameter of approximately 10 μm to 100 μm) in advance in accordance with the landing area of a droplet E by causing the third supporting mechanism 19C to move the condenser lens 7d in the Z direction. Note that, the interval between two adjacent droplets E in the X direction is adjusted by changing the angle of the droplet jetting head H2 in the θ direction.

As shown in FIG. 8, the positioning is performed as the alignment process (Step S1). After the positioning, it is determined whether or not the offset of the positioning is within a predetermined range (Step S2). Step S1 is then repeated until the offset falls within the predetermined range (when the determination in Step S2 is NO).

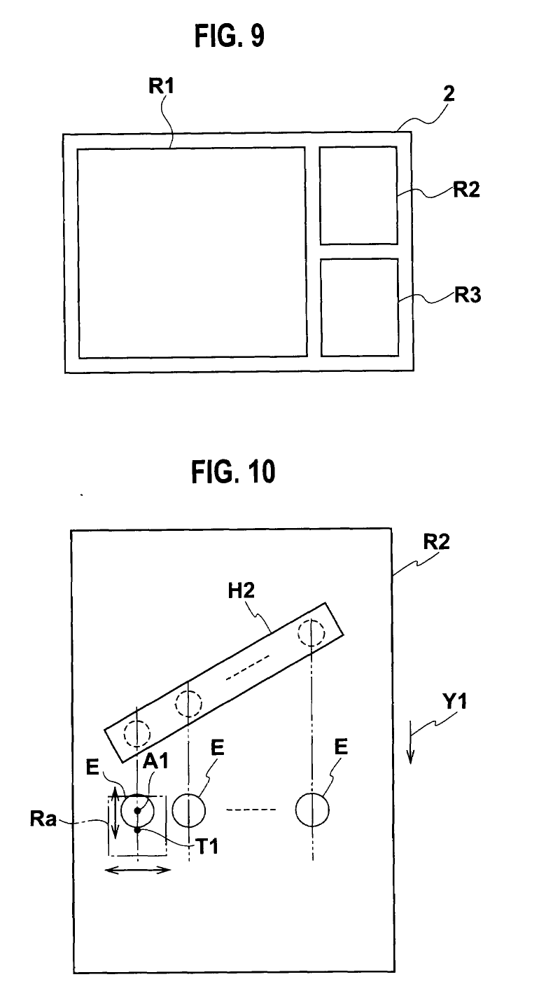

Here, as shown in FIG. 9, a first region R1 for manufacture, a second region R2 on which a droplet is caused to land, and a third region R3 on which a laser beam is irradiated, are provided on the substrate 2 for the application operation including the alignment process. The second and third regions R2 and R3 function as a region for the alignment. Note that, the water-repellent film 2a is formed in each of the first and second regions R1 and R2, and concurrently a material that shows an irreversible change in color due to laser irradiation (for example, ultraviolet irradiation) is applied to the third region R3.

In the alignment process, the landing position (application position) of each droplet E is aligned with the irradiation position of a corresponding laser beam. Firstly, as shown in FIG. 10, droplets E are jetted once to the second region R2 on the substrate 2 by the droplet jetting head H2 on the basis of the application information. By this jetting, the droplets E land in line on the second region R2 on the substrate 2. Here, the arrow Y1 in FIG. 10 indicates the moving direction of the substrate 2. Note that, the application information is information about the application operation performed on the substrate 2, and includes the application pattern, (for example, a dot pattern), the transporting speed of the substrate 2, the irradiating time, the irradiating timing, and the jetting timing.

The landing position of each droplet E is adjusted so that the head application point A1 (the center point of a droplet positioned at the left end in FIG. 10) can overlap the center point T1 of an imaging region Ra of the imaging part Pa. Specifically, an image captured by the imaging part Pa is subjected to image processing, so that the amount of offset between the head application point A1 and the center point T1 is calculated. The stop position of the imaging part Pa at this time has been set so that the center point T1 can face a predetermined landing position (design values). Then, on the basis of the calculated amount of offset, the application information is adjusted. This adjustment at this time includes, for example, adjustment of the position of the substrate holding table 15 (see FIG. 1) of the substrate moving mechanism 6, and adjustment of the jetting timing of the droplet jetting head H2. The amount of offset in the X direction is decreased by the adjustment of the position of the substrate holding table 15. The amount of offset in the Y direction is decreased by the adjustment of the jetting timing. In the above-described manner, the landing position of each droplet E is adjusted so that the head application point A1 can overlap the center point T1 of the imaging region Ra of the imaging part Pa.

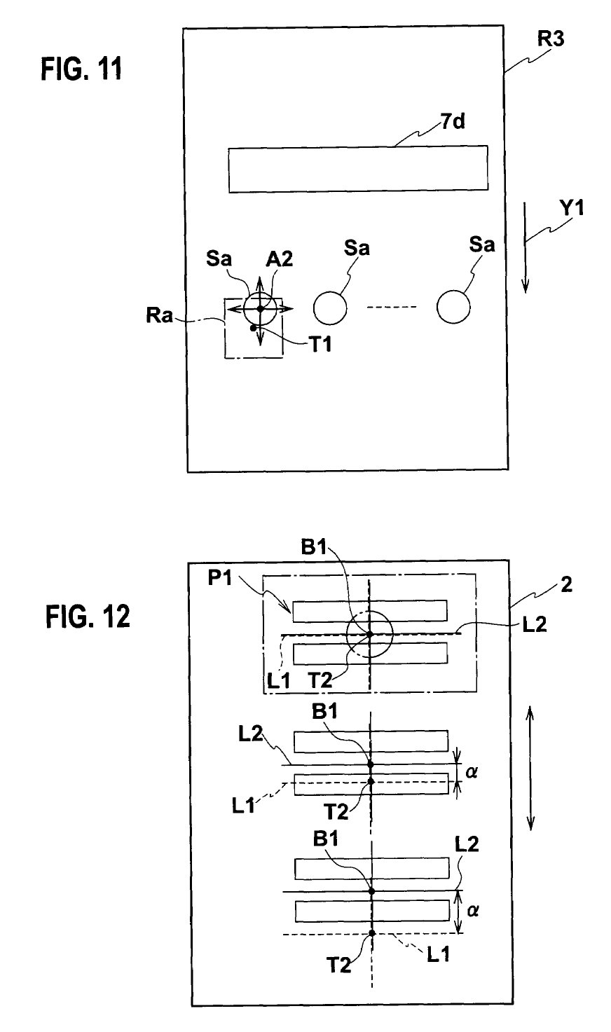

In addition, as shown in FIG. 11, laser beams scanned after being intermittently emitted on the basis of the application information are focused by the condenser lens 7d onto the third region R3 on the substrate 2. Accordingly, circular color-changed portions Sa are formed in-line in the third region R3 on the substrate 2. Here, the arrow Y1 in FIG. 11 indicates the moving direction of the substrate 2.

The irradiation position of each laser beam is adjusted so that a head irradiating point A2 (the center point of the color-changed portion Sa at the left end in FIG. 11) can overlap the center point T1 of the imaging region Ra of the imaging part Pa. Specifically, an image captured by the imaging part Pa is subjected to image processing, so that the amount of offset between the head irradiating point A2 and the center point T1 is calculated. The position where the imaging part Pa stays at this time has been set so that the center point T1 can face the predetermined landing position (design values). Then, on the basis of the calculated amount of offset, the application information is adjusted. This adjustment at this time includes, for example, adjustment of the position of the deflector c1, and adjustment on the irradiating timing (such as, the output timing of the pulse signal) of the laser light source 7a. The amount of offset in the X direction is decreased by the adjustment of the position of the deflector c1. The amount of offset in the Y direction is decreased by the adjustment of the irradiating timing. Note that, the position of the deflector c1 is adjusted in consideration of the correction amount in the above-described adjustment of the position of the substrate holding table 15. In the above-described manner, the irradiation position of each laser beam is adjusted so that the head irradiating point A2 can overlap the center point T1 of the imaging region Ra of the imaging part Pa. As a result of the adjustment, the landing position of each droplet E coincides with the irradiation position of the corresponding laser beam on the basis of the design values.

Subsequently, when it is determined that the amount of offset is within the predetermined range (YES in Step S2), the application operation is performed on the basis of the adjusted application information (Step S3). In the application operation, a droplet E is jetted to the first region R1 on the substrate 2. This application operation is basically the same as that performed in the first embodiment.

First of all, the controller 27 controls the substrate moving mechanism 6 and the base plate 18 on the basis of the application information, so that the droplet jetting head H2 and the condenser lens 7d are moved to the application starting position facing the substrate 2. Subsequently, the controller 27 controls the substrate moving mechanism 6 on the basis of the application information. In addition, the controller 27 controls the irradiation-head unit 7B so that laser beams are intermittently emitted from the irradiation-head unit 7B to be scanned in the X direction. Each light beam is thus irradiated in the dot shape onto the substrate 2. Moreover, the controller 27 controls the droplet jetting head H2, so that a droplet E is jetted to each of the hydrophilic regions S on the substrate 2. Accordingly, the droplets E are sequentially applied in a dot-line pattern on the surface of the substrate 2 to form the application pattern thereon. Note that, the irradiating time of the laser beams is set so that the water-repellent film 2a on the substrate 2 can be evaporated by the thermal energy of each light beam in the irradiating time. Meanwhile, the moving speed of the substrate 2, the emission pulse of the laser beams, and the scanning speed of the deflection scanner 7c (displacement of the deflector c1) are synchronized with one another.

At this time, with the intermittent emission and scanning of the laser beams based on the irradiating time and the irradiating timing (the pulse signals transmitted as the control signals to the laser light source 7a), the condenser lens 7d sequentially irradiates the laser beams, in a dot line aligned with the X direction, onto the water-repellent film 2a on the substrate 2 moving in the Y-direction. Specifically, in the process of irradiating laser beams, laser beams are intermittently emitted as light beams for removing the water-repellent film 2a. Each of the light beams thus emitted is expanded, and is synchronized with the intermittent operation of the laser light source 7a. The expanded laser beam is deflected to be scanned, and the scanned laser beam is focused onto the water-repellent film 2a, so that a dot-shaped light beam is irradiated onto the surface of the water-repellent film 2a. With this process, the irradiated part of the water-repellent film 2a on the substrate 2 is evaporated by the heat of the light beam, so that the multiple hydrophilic regions (hydrophilic portions) S, which are parts, each exposed due to the evaporation in the dot shape, of the surface of the substrate 2, are formed in the dot-line pattern aligned with the X direction. Each of these hydrophilic regions S is formed in a circular shape. After that, in accordance with the jetting timing, the droplet jetting head H2 causes droplets E to land on, and thus applies the droplets E to, the corresponding hydrophilic regions S on the substrate 2 moving in the Y direction. As a result, the dot-line patterns each aligned with the X direction are formed sequentially in the Y direction, so that the application pattern is completed. Note that, the jetting timing is set in accordance with the transporting speed of the substrate 2 so that each of the droplets E can land on a corresponding one of the hydrophilic regions S on the substrate 2. As described above, since the irradiation positions of the laser beams intermittently emitted from the irradiation-head unit 7B can be changed at a high speed, dot-shaped light beams can be irradiated on to the water-repellent film 2a with a simple configuration. Moreover, it is also possible to easily form the same number of lines of the hydrophilic regions S as that of the nozzles of the droplet jetting head H2.

With the above-described application operation, as in the case of the first embodiment, the droplets E landing on the hydrophilic regions S are prevented from moving in a sliding manner due to the water repellent film 2a surrounding the hydrophilic region S. Accordingly, each of the landing droplets E can be prevented from being displaced from its predetermined landing position. In addition, for example, even when one of the droplets E lands on the boundary between its corresponding hydrophilic region S and the water-repellent film 2a, that droplet E is drawn by the hydrophilic region S to be positioned on the hydrophilic region S. Moreover, the areas of the hydrophilic regions S are uniformly formed, and the droplets E are applied thereto. Accordingly, since the landing area of each droplet E coincides with the area of each hydrophilic region S, the droplets E are caused to have a uniform landing diameter.

As have been described so far, according to the third embodiment of the present invention, the same effects as those of the first embodiment can be obtained. Moreover, the irradiation-head unit 7B includes: the laser light source 7a, which intermittently emits laser beams as light beams for removing the water-repellent film 2a; the beam enlarger 7b, which expands the emitted laser beams; the deflection scanner 7c, which deflects each of the expanded laser beams for scanning in synchronization with the intermittent operation of the laser light source 7a; and the condenser lens 7d, which focuses each of the scanned laser beams onto the water-repellent film 2a. Accordingly, since the irradiation positions of the laser beams intermittently emitted can be changed at a high speed, dot-shaped light beams can be irradiated onto the water-repellent film 2a with a simple configuration. Moreover, it is also possible to easily form the same number of lines of the hydrophilic regions S as that of the nozzles of the droplet jetting head H2.

In addition, the third embodiment includes, before the process of irradiating laser beams, the process (alignment process) in which the irradiation position of each laser beam is aligned with the landing position of a corresponding one of the droplets E. Accordingly, the landing position of each droplet E coincides with the generating position of a corresponding one of the hydrophilic regions S with a high accuracy. As a result, each droplet E can be securely prevented from being displaced from the corresponding predetermined landing position.

Note that, in the case where the substrate 2 is large-sized, displacement of irradiation positions, or displacement of drawing positions sometimes occurs due to expansion or shrinkage of the substrate 2. In order to suppress such displacement, the irradiating timing and the jetting timing are corrected in accordance with the amount of expansion or shrinkage of the substrate 2. Here, as shown in FIG. 12, multiple patterns P1, such as wiring patterns, are formed on the substrate 2. In addition, in FIG. 12, reference symbol L1 denotes a cross line indicating an ideal center position T2, reference symbol L2 denotes a cross line indicating an actual center position B1, and reference symbol a denotes an offset amount. Firstly, before the irradiation of light beams and the application, an image of each pattern P1 is captured by the imaging part Pa. Each of the captured images is then subjected to image processing, so that the actual center position B1 of each pattern P1 is detected. From the detected center positions B1, a pattern interval between each adjacent two of the patterns P1 is obtained. Subsequently, the difference (offset amount a) between the actual center position B1 based on each pattern interval and the ideal center position T2 based on an ideal pattern interval is obtained as an amount for correction. The irradiating timing and the jetting timing are adjusted on the basis of the amount for correction. As a result, it is possible to suppress an influence of the expansion or shrinkage of the substrate 2, and to thus prevent the displacement of the irradiation positions and that of the drawing positions, which would otherwise occur due to the expansion and shrinkage of the substrate 2.

On the other hand, in some cases, displacement of irradiation positions, or displacement of drawing positions may occur due to misalignment on the order of microns caused by strain in a device such as a shaft about or on which a stage is movable. In order to suppress such displacement, an image of the substrate (ideal substrate) 2 to be used as a reference is captured by the imaging part Pa, so that the position of each pattern is detected. Then, data on the detection is stored as misalignment data to be used as an amount for correction for the individual applicator. When an application operation is to be performed on another substrate 2, the amount for correction is used. This configuration makes it possible to suppress misalignment due to strain in a device such as a shaft about or on which a stage is movable, and to thus suppress displacement of irradiation positions and that of drawing positions, which would otherwise occur due to the misalignment.

### Other Embodiments

It should be noted that the present invention is not limited to the above-described embodiments, and various modification may be made on the present invention without departing from the scope of the present invention.

For example, although the shutter 71c is used in the first embodiment, the present invention is not limited to this configuration. It is also possible to remove the shutter 71c and employ a configuration in which a xenon flash lamp or the like is used as the light source 71b, and in which ON and OFF operations of the light source 71b are controlled on the basis of irradiating time and irradiating timing.

In addition, although, in the first to third embodiments, the substrate 2 is moved with respect to the irradiation head H1 and the droplet jetting head H2, the present invention is not limited to this configuration. It is also possible that the irradiation head H1 and the droplet jetting head H2 are moved with respect to the substrate 2. What is essential is that the substrate 2 and each of the irradiation head H1 and the droplet jetting head H2 are moved relative to each other.

Moreover, although, in the first to third embodiments, only one droplet jetting head H2 is provided, the present invention is not limited to this configuration. Multiple droplet jetting heads H2 may be provided, and there is no limitation to the number of droplet jetting heads H2. In this case, the number of irradiation heads H1 may also be increased to correspond to the number of droplet jetting heads H2. Alternatively, the size of an irradiation head H1 may be increased to match the width of application region as corresponding to the application region of the substrate 2.

Furthermore, although, in the first to third embodiments, a light beam is irradiated in a circular shape onto the surface of the water-repellent film 2a on the substrate 2, the present invention is not limited to this configuration. For example, a light beam may be irradiated in a square or rectangular shape instead.

Lastly, although, in the first to third embodiments, various numerical values are presented, these values are mere examples, thus not limiting the present invention.

What is claimed is:

1. A droplet jetting applicator comprising:
an irradiator configured to irradiate, to a water-repellent film formed on a surface of an application target, a light beam for removing the water-repellent film; and
a droplet jetting head configured to jet a droplet to each of a plurality of hydrophilic regions of the surface of the application target, each of the hydrophilic regions being exposed to the outside in a dot shape by removing the water-repellent film.

2. The droplet jetting applicator according to claim 1 further comprising a moving mechanism configured to cause the application target and each of the irradiator and the droplet jetting head to move relative to each other so that the application target can pass through an irradiation position on which the laser beam is irradiated by the irradiator, and also an application position to which the droplet is jet by the droplet jetting head.

3. The droplet jetting applicator according to claim 1 further comprising an optical system configured to focus the light beam in a circular dot shape on a surface of the water-repellent film.

4. The droplet jetting applicator according to claim 2 further comprising an optical system configured to focus the light beam in a circular dot shape on a surface of the water-repellent film.

5. The droplet jetting applicator according to claim 1 wherein the irradiator comprising:
a laser light source configured to intermittently emit a laser beam as the light beam;
a beam enlarger configured to expand the laser beam emitted;
a deflection scanner configured to deflect the expanded laser beam, and to thus scan the expanded laser beam, in synchronization with the intermittent operation of the laser light source; and
a condenser lens configured to focus the scanned laser beam on the water-repellent film.

6. The droplet jetting applicator according to claim 2 wherein the irradiator comprising:
a laser light source configured to intermittently emit a laser beam as the light beam;
a beam enlarger configured to expand the laser beam emitted;
a deflection scanner configured to deflect the expanded laser beam, and to thus scan the expanded laser beam, in synchronization with the intermittent operation of the laser light source; and
a condenser lens configured to focus the scanned laser beam on the water-repellent film.

7. A method of manufacturing a coated body comprising:
irradiating, to a water-repellent film formed on a surface of an application target, a light beam for removing the water-repellent film; and
jetting a droplet to each of a plurality of hydrophilic regions of the surface of the application target, each of the hydrophilic regions being exposed to the outside in a dot shape by removing the water-repellent film.

8. The method of manufacturing a coated body according to claim 7 wherein
the application target is moved during the irradiation of the light beam; and
the application target is moved during the jetting of the droplet.

9. The method of manufacturing a coated body according to claim 7 wherein, the light beam is irradiated in a dot shape on a surface of the water-repellent film by using an optical system configured to focus the light beam in a circular dot shape on the surface of the water-repellent film.

10. The method of manufacturing a coated body according to claim 8 wherein, the light beam is irradiated in a dot shape on a surface of the water-repellent film by using an optical system configured to focus the light beam in a circular dot shape on the surface of the water-repellent film.

11. The method of manufacturing a coated body according to claim 7 wherein, a laser beam is intermittently emitted as the light beam; the emitted laser beam is expanded; the expanded beam is deflected and thus scanned in synchronization with the intermittent emission of the laser beam; and then the scanned laser beam is focused on the water-repellent film so as to be irradiated in a dot shape on the surface of the water-repellent film.

12. The method of manufacturing a coated body according to claim 8 wherein, a laser beam is intermittently emitted as the light beam; the emitted laser beam is expanded; the expanded beam is deflected and thus scanned in synchronization with the intermittent emission of the laser beam; and then the scanned laser beam is focused on the water-repellent film so as to be irradiated in a dot shape on the surface of the water-repellent film.

13. The method of manufacturing a coated body according to claim 7 further comprising, before the irradiation of the light beam, aligning the landing position of the droplet on the surface of the application target with the irradiation position of the light beam on the surface of the application target.

14. The method of manufacturing a coated body according to claim 8 further comprising, before the irradiation of the light beam, aligning the landing position of the droplet on the surface of the application target with the irradiation position of the light beam on the surface of the application target.
